(19) United States
(12) Patent Application Publication
(10) Pub. No.: US 2009/0211387 A1
(43) Pub. Date: Aug. 27, 2009

(54) Spiral Gear

(75) Inventors: Albert Pogosyan, Yerevan (AM); Suren Pogosyan, Yerevan (AM)

Correspondence Address: PAULEY PETERSEN & ERICKSON, 2800 WEST HIGGINS ROAD, SUITE 365, HOFFMAN ESTATES, IL, 60169, US

(73) Assignees: EMIL GRIGORYAN, Yerevan (AM); ALBERT POGOSYAN, Yerevan (AM); SUREN POGOSYAN, Yerevan (AM)

(21) Appl. No.: 11/918,195

(22) PCT Filed: Mar. 20, 2006
(86) PCT No.: PCT/AM2006/000004

§ 371 Date: Jan. 16, 2009

(30) Foreign Application Priority Data
Apr. 11, 2005 (AM) P20050043

(51) Int. Cl. F16H 1/18; F16H 25/20

(52) U.S. Cl. 74/424.78

(57) ABSTRACT

A spiral gear having a body, a compound nut and a screw on which a keyway is made on the longitudinal direction. The nut has four or more inserts placed in the grooves made in the longitudinal direction and leaning against the inclined surfaces made at different heights in the same direction on the end parts of the bottoms of the grooves. The spiral support with the conical surface placed coaxial in the hole of the body leans against the conical surfaces made on the butt-ends of the inserts from one side and leans from the other side the imitator with the respective conical surface. On the other butt-end of the imitator are two small balls against two inclined spiral surfaces made in the direction of the screw which have the same height, and the spiral disk.

### BACKGROUND OF THE INVENTION

1. Field of the Invention

This invention relates to machine construction and can be applied in automated equipment, quick clamps, jacks and vices.

2. Discussion of Related Art

Spiral gear are known which have a nut made of two semicircles which, on their butt-ends, have imitators for moving in diametrical directions, a screw with a longitudinal groove on which the carrier is based with a spiral catch, and a handle which fixes the carrier on the body by a spiral pin when the gear is moved by spiral force or load action, such as when lifting weight by a jack (U.S. Pat. No. 5,970,812, MAD F16H 1/18, 1999).

The above spiral gear has disadvantages, including that the existence of an additional mechanism of fixing the imitator carrier increases the size of the gear. Also, the possibility of fixing the handle only on the cantilever edge of the screw makes the operation of the gear difficult, whereas with the help of the handle, the semicircles of the nut can be hooked and unhooked instantly through the imitator relative to the screw at the same time as fixing it.

### SUMMARY OF THE INVENTION

Performing the diametrical movement of the nut at its butt-ends, through the imitator, increases the size of the gear and reduces its reliability. The rotation of the imitator in both directions through the carrier based on the screw with the help of the spiral catch reduces reliability and operates with noise. In order to eliminate the above disadvantages, this invention provides for control of the compound nut without any additional controlling element and respective mechanism, as well as increasing the reliability of the gear and reducing its size. To achieve these goals, the nut is made of four and more inserts placed in the grooves, in a longitudinal direction of the hole and lean, by their respective inclined surfaces, against the inclined surfaces made at different heights in the same direction on the end parts of the bottoms of the grooves. The spiral support with a conical surface placed coaxially in the hole of the body leans against the conical surfaces made on the butt-ends of the inserts from one side and from the other side the imitator with the respective conical surface, which is positioned coaxial in the hole of the body and has an ability to move only in the direction of the axis, leans against the conical surfaces made on the butt-ends of the inserts, and the spiral disk freely placed in the hole of the body leans through two small balls against two inclined spiral surfaces on the other side of the imitator which have the same height. At the same time in this position, the spiral disk leans against the body with an ability to move in the direction of the axis, and through the key is tied to the screw, and the screw, in turn, is freely placed in the coaxial guides in the ends of the body hole. The inserts have projections at their ends through which they lean against the flat surface of the butt-ends of the grooves when performing the gear.

### BRIEF DESCRIPTION OF THE DRAWINGS

This invention is detailed in the drawings, wherein:

FIG. 1 is a longitudinal sectional view of a spiral gear as shown;

FIG. 2 shows a section taken along line A-A of FIG. 1;

FIG. 3 shows a section taken along line B-B of FIG. 1; and

FIG. 4 shows a section taken along line B-B of FIG. 1.

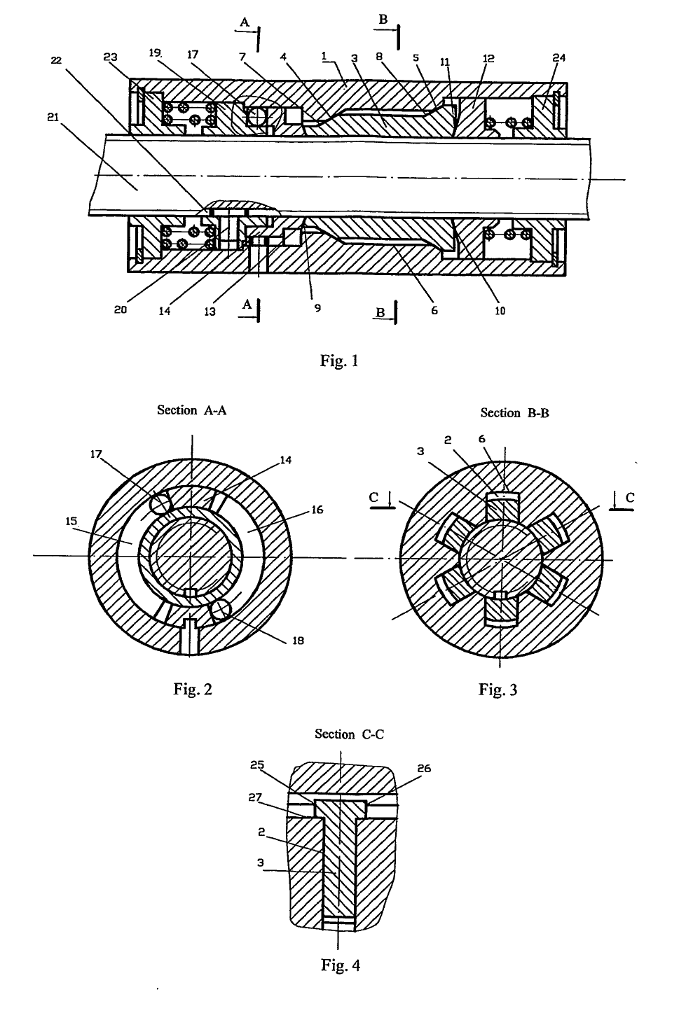

### DETAILED DESCRIPTION OF THE INVENTION

The spiral gear has a body (1) in which, in the longitudinal direction of the surface of the stepped hole, grooves (2) are made in which inserts (3) are placed which lean against the bottoms (4) of the grooves (2), such as with their respective inclined surfaces (7, 8) against the inclined surfaces (5,6) made on the end parts in the same direction at different height. The spiral support (12) placed coaxial in the hole of the body (1) leans against the conical surfaces (9, 10) made on the butt-ends of the inserts (3) from one side: From the other side the imitator (14) with a respective conical surface (13) is placed coaxially in the hole of the body (1) and has the ability to move only in the direction of the axis. The spiral disk (19) is freely placed in the hole of the body (1) and leans through two small balls (17, 18) against two inclined spiral surfaces made at the same height on the other side of the imitator (14). At the same time in this position, the spiral disk (19) leans against the body (1) through the key (20), with the ability to move in the direction of the axis, and is connected to the screw (21) which has a groove (22) along its longitudinal direction. The screw (21), in turn, is freely placed in the coaxial guides (23, 24) made on the end parts of the hole of the body (1).

Through projections (25, 26) made on the end parts lean against the spiral support (12). The inserts, in turn, lean against the flat surface (27) of the butt-ends of the grooves (2). The spiral force of the disk (19) is up to twice larger than that of the support (12).

The gear force of the spiral gear acts in one direction. In the event of spiral or load action it operates in two directions. In the absence of any action, when making one turn of the screw in the opposite direction, the nut is released from the hooked position relative to the screw which takes places as follows: when making one turn of the screw (21) leftwards, such as counter-clockwise, the disk (19) turns together with the screw through the key (20), and the disk (19), in turn, shifts the imitator (14) in the direction of the axis at the height of the respective inclined surfaces (15, 16) by rolling the balls (17, 18) on the inclined surfaces (15, 16) with equal heights on the butt-end of the imitator (14). After the shifting, the imitator (14) moves the inserts (3) in the direction of the axis with the conical surface (13) made on its butt-end, through interacting with the conical surface (9) on the butt-ends of the inserts (3). Leaning against the conical surface (11) of the spiral support (12) with their conical surface (10) on the other butt-end, the inserts shift the spiral support (12) to the respective extent.

After the shifting takes place, the inserts (3) squeezed against the conical surfaces (11, 13) by the spiral force, at the same time, through the force exerted on them in the diametrical direction gradually divaricate in relation to the axis of the body (1), unhooking relative to the screw which takes place as the inclined surfaces (5, 6) made in the same direction at different heights on the bottoms of the grooves (2) in the hole of the body, i.e. end parts, and the respective inclined surfaces (7, 8) on the end parts of the inserts (3) which lean against the above inclined surfaces (5, 6). In this position, the screw (21) can be freely shifted to any position into the guides (23, 24) made in the end parts of the hole of the body (1). When turning the screw (21) leftward or counter-clockwise, the inserts (3) are not released from the hooked position if there are forces equal or above the spiral force of the disk (19) exhorted in the opposite direction of the gear. This action takes place by turning the screw leftwards, or counter-clockwise, the disk (19) turns leftwards through the key (20) and rolling the balls (17, 18) along the inclined surfaces (15, 16) of the imitator (14), the disk (19) shifts along the axis of the hole of the body (1) opposite its spiral force, because the force exhorted on the inserts (3) in the opposite direction of the gear is larger than the spiral force of the disk (19). When turning the screw (21), the inserts (3) are retained in their hooked position and start shifting in the opposite direction of the gear until the force exhorted in the opposite direction of the gear stops when after one turn of the screw (21) the unhooking of the inserts (3) from the screw takes place after the above-described action.

In order to get the inserts (3) in the hooked position relative to the screw (21), the screw (21) turns one round rightwards or clockwise, and together with it, through the key (20), the disk (19) turns, which, in turn, rolls the balls (17,18) along the two inclined surfaces (15, 16) on the butt-end of the imitator (14) to their previous position, thus allowing the imitator (14), through the spiral support (12) of the inserts (3) to move gradually in the opposite direction to its previous position and to bring the inserts (3) in a hooked position relative to the screw (21). The screw (21) is kept turning in the same direction, and the inserts (3) together with the body (1) will shift relative to the screw (21) in the direction of the gear.

The new technical solutions introduced in the spiral gear allow controlling of the gear without an additional mechanism, by turning or rotating in the respective direction through the screw or nut, as well as increasing the reliability of the gear, reducing its size and improving the operational possibilities.

1. A spiral gear having a body, a compound nut and a screw on which a keyway is along a longitudinal direction, comprising: the nut having at least four inserts placed in grooves made in the longitudinal direction of the hole and leaning by their respective inclined surfaces against second inclined surfaces at different heights in a same direction on end parts of bottoms of the grooves, a spiral support with the conical surface placed coaxially in the hole of the body leaning against the conical surfaces on butt-ends of the inserts from one side and from an other side the imitator with the respective conical surface placed coaxially in the hole of the body and having an ability to move only in a direction of an axis leaning against the conical surfaces on the butt-ends of the inserts, and the spiral disk freely placed in the hole of the body leaning through two balls against two inclined spiral surfaces on the other side of the imitator which have the same height, and at a same time in this position the spiral disk leaning against the body with an ability to move in the direction of the axis, and through the key connected to the screw, the screw freely placed in the coaxial guides on the end parts of the body hole, and the inserts having projections at their ends through which they lean against a flat surface of the butt-ends of the grooves when moving the gear.
